(19) United States
(12) Patent Application Publication
(10) Pub. No.: US 2004/0084966 A1
(43) Pub. Date: May 6, 2004

(54) Simple automated source switch

(76) Inventor: William A. Yarbrough, Germantown, TN (US)

Correspondence Address: James R. Yee, HOWARD & HOWARD ATTORNEYS, P.C., The Pinehurst Office Center, Suite #101, 39400 Woodward Avenue, Bloomfield Hills, MI, 48304-5151, US

(21) Appl. No.: 10/694,288

(22) Filed: Oct. 27, 2003

Related U.S. Application Data
(60) Provisional application No. 60/424,272, filed on Nov. 6, 2002.
(60) Provisional application No. 60/473,301, filed on May 23, 2003.

(51) Int. Cl. H02J 9/00; H02J 7/00

(52) U.S. Cl. 307/64; 307/80

(57) ABSTRACT

A switching system for providing electrical power to at least one load. The system includes a primary power device, a secondary power device, and an automatic switch. The switch includes an electromechanical relay with an electro-magnetically actuated multi-pole activator, an electromagnet, and a biasing means. The multi-pole activator is switched between the primary and secondary power devices to carry any available power to the loads. The electromechanical relay includes a primary terminal, a secondary terminal, and an output terminal. The primary power device is electrically connected to the primary terminal. The secondary power device is electrically connected to the secondary terminal. The loads are connected to the output terminal. The automatic switch also includes a coupling terminal is utilized to provide electrical power from the secondary power device to the primary power device.

### CROSS-REFERENCES TO RELATED APPLICATIONS

The subject patent application claims priority to and all the benefits of U.S. Provisional Patent Application Serial No. 60/424,272, which was filed on Nov. 6, 2002, and U.S. Provisional Patent Application Serial No. 60/473,301, which was filed on Jun. 23, 2003.

### FIELD OF THE INVENTION

The present invention relates generally to the supply of electrical power to systems, and more particularly, to an apparatus which automatically switches between first and second power devices in response to power loss and/or restoration of power.

### BACKGROUND OF THE INVENTION

Computer, telecommunication systems, medical equipment, and other electrical loads are often used in critical processes. Generally these loads are provided with electrical power through a primary power device, e.g., a power grid, electrical generator, or an uninterruptible power supply (UPS). It is known to use a secondary power device, e.g., a second UPS, to supply electrical power when the primary power device fails or is offline.

Generally, UPSs store electrical power in batteries from a supplied power source. An electronic circuit, internal to the UPS, may be used to detect the loss of the supplied power source and switch to the batteries. The electronic circuit includes electronic components, such as silicon controlled rectifiers (SCR), triacs, capacitors, etc., which may fail. In the case of loss of the supplied power source and failure of the UPS, the critical loads will be without power.

Additionally, the UPS will need either repair, replacement and/or maintenance. During repair, replacement, and/or maintenance, the UPS may be offline and will be unable to supply power.

The present invention is aimed at one or more of the problems set forth above.

### BRIEF SUMMARY OF THE INVENTION

A switching system for maintaining electrical power to a load comprises a primary power device, a secondary power device, and an automatic switch. The automatic switch includes a primary terminal electrically connected to the primary power device, a secondary terminal electrically connected to the secondary power device, and an output terminal for providing electrical power to the load. The automatic switch also includes an electromechanical relay for automatically switching the source of electrical power to the load between the primary power device and the secondary power device. The relay includes a first relay input terminal electrically connected to the primary terminal, a second relay input terminal electrically connected to the secondary terminal, and a relay output terminal electrically connected to the output terminal. The relay also includes an electromagnet electrically connected to the first relay input terminal. The relay further includes a electro-magnetically actuated multi-pole activator for electrically connecting the first relay input terminal to the relay output terminal when the electromagnet is energized and for electrically connecting the second relay input terminal to the relay output terminal when the electromagnet is not energized. A biasing means is operatively connected to the multi-pole activator for assisting in the switching of the multi-pole activator when the electromagnet is not energized. The switching system is characterized by a coupling terminal electrically interconnecting the secondary terminal and the primary power device for transmitting electrical power from the secondary power device to the primary power device.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a diagrammatic illustration of a switching system to supply electrical power to one or more loads from a primary power device or a secondary power device, according to an embodiment of the present invention;

FIG. 2 is a diagrammatic illustration of the switching system to supply electrical power to one or more loads from a primary uninterruptible power supply (UPS) or a secondary UPS, according to a first embodiment of the present invention; and

FIG. 3 is a diagrammatic illustration of the switching system to supply electrical power to one or more loads from the primary UPS or an external power source, according to a first embodiment of the present invention.

### DETAILED DESCRIPTION OF THE INVENTION

Referring to the Figures, wherein like numerals indicate like or corresponding parts throughout the several views, a switching system is shown at 10. The switching system 10 maintains electrical power to a load 12. The switching system 10 includes an automatic switch 11, a primary power device 14, and a secondary power device 16.

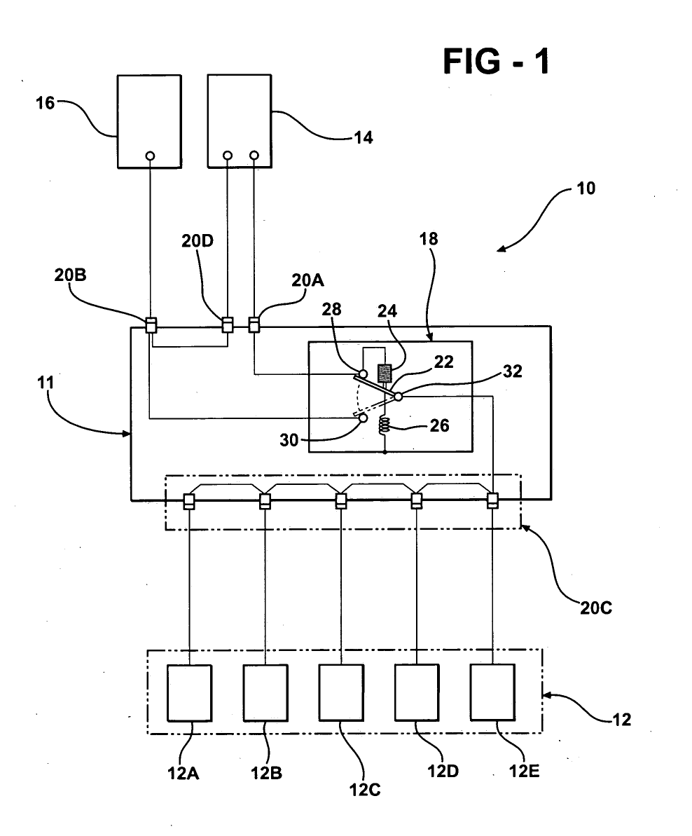

Referring to FIG. 1, the primary and secondary power devices 14, 16 may be any type of power device, including, but not limited to, an uninterruptible power supply (UPS), a generator, a power conditioner, or a utility power source.

The automatic switch 11 provides a means for automatically switching electrical power between the primary power device 14 and the secondary power device 16. The switch 11 senses when the primary power device 14 has failed, or otherwise stops providing power, and automatically switches to the secondary power device 16. Additionally, when the primary power device 14 is restored, the switch 10 automatically switches back to the primary power device 14.

The automatic switch 11 includes a primary terminal 20A electrically connected to the primary power device 14 and a secondary terminal 20B electrically connected to the secondary power device 16. The automatic switch 11 also includes an output terminal 20C for providing electrical power to the load 12.

The automatic switch 11 also includes a coupling terminal 20C electrically interconnecting the secondary terminal 20B and the primary power device 14. This coupling terminal 20D allows for routing of electrical power from the secondary power device 16 to the primary power device 14.

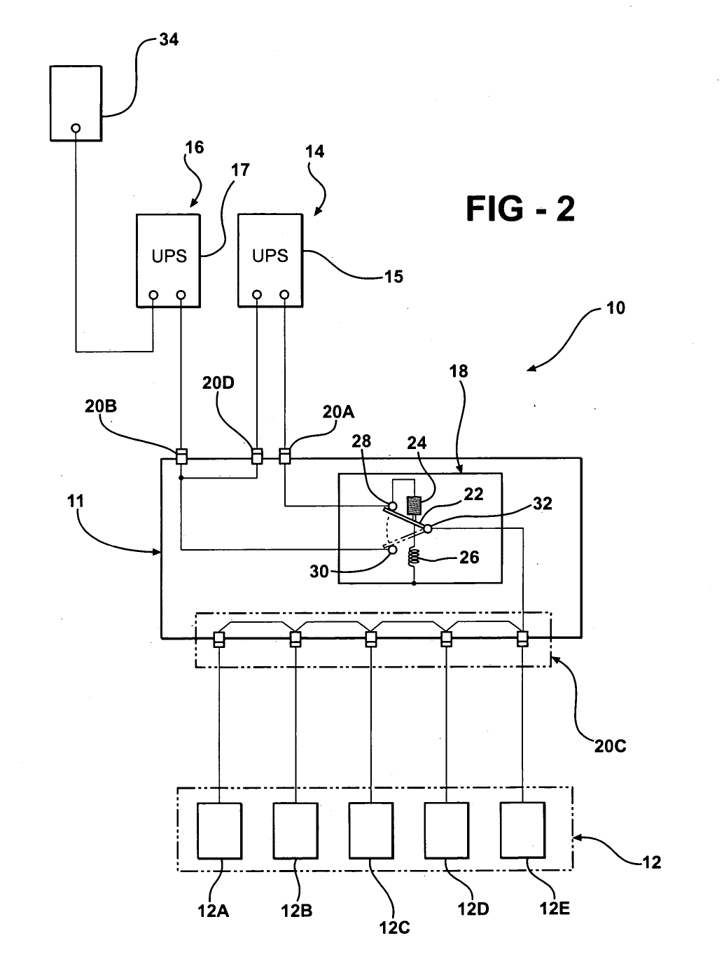

In a first embodiment of the invention, as shown in FIG. 2, the primary power device 14 is a primary UPS 15 for storing and supplying electrical power. The secondary power device 16 is a secondary UPS 17, also for storing and supplying electric power. An external power source 34, such as utility power, is electrically connected to the secondary UPS 17 to provide electrical power to the secondary UPS 17. The coupling terminal 20C allows the primary UPS 15 to receive power from the secondary UPS 17.

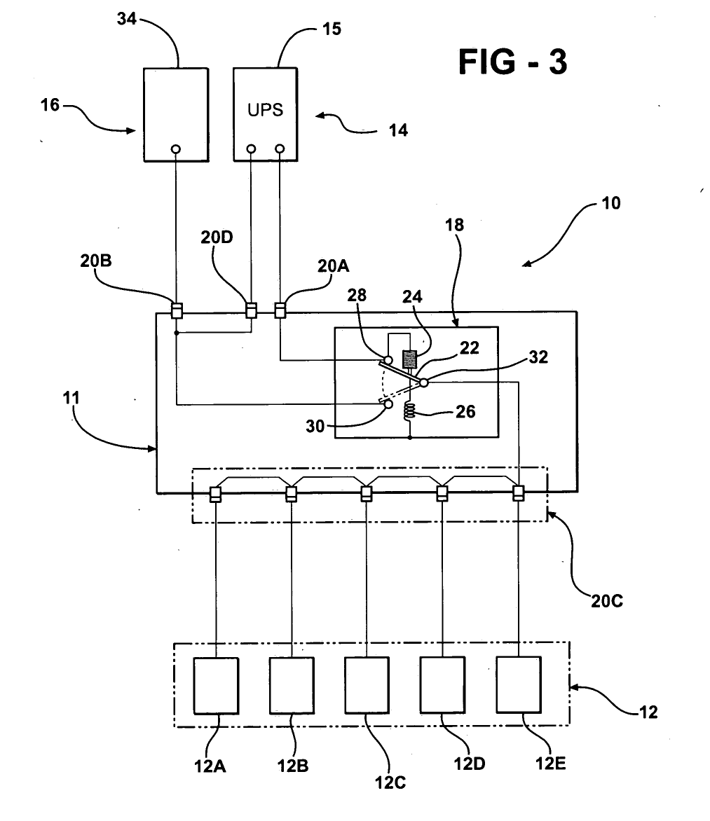

As previously stated, many alternate embodiments can also be contemplated by those skilled in the art. In a second embodiment, as shown in FIG. 3, the primary power device 14 is the primary UPS 15 and the secondary power device 16 is the external power source 34.

The automatic switch 11 further includes an electromechanical relay 18. The relay 18 automatically switches the source of electrical power sent to the load 12 between the primary power device 14 and the secondary power device 16. The relay 18 comprises a first relay input terminal 28 electrically connected to the primary terminal 20A and a second relay input terminal 30 electrically connected to the secondary terminal 20B. A relay output terminal 32 is electrically connected to the output terminal 20C.

The relay further includes an electromagnet 24. The electromagnet is electrically connected to the first relay input terminal 28, such that the electromagnet 24 becomes energized when a sufficient amount of power is present on the first relay input terminal 28. An electro-magnetically actuated multi-pole activator 22 electrically connects the first relay input terminal 28 to the relay output terminal 32 when the electromagnet 24 is energized. A biasing means 26 is operatively connected to the multi-pole activator 22, so that when the electromagnet 24 is not energized, the multi-pole activator 22 makes an electrical connection between the second relay input terminal 30 and the relay output terminal 32. In the first embodiment, the biasing means 26 is a spring 26. In an alternate embodiment, the biasing means 24 includes a permanent magnet (not shown).

The electromagnet 24 and biasing means 26 must be adequately designed to quickly actuate the multi-pole activator 22 without disrupting electrical power to the load 12. In one embodiment, the electromagnet 24 may be an air-core type to preclude residual magnetism, so that the critical balance between the competing electromagnet 24 and biasing means 26 is preserved.

If the primary device 14 fails or is taken offline, power is no longer supplied to the electromagnet 24. The biasing means 26 trips the multi-pole activator 22, thereby making an electrical connection between the second relay input terminal 30 and the relay output terminal 32. Power is then supplied to the loads 12 via the secondary power device 16. The transfer between power devices 14, 16 occurs without human or external intervention and does not interrupt the ongoing critical process performed by the loads 12.

Once the primary power device 14 has been repaired or maintenance has been completed and it is back online, power is supplied to the electromagnet 24, again closing the connection between the first relay input terminal 28 and the relay output terminal 32. Power is again supplied to the loads 12 via the primary power device 14.

Those skilled in the art appreciate that the output terminal 20C may consist of several electrical connections in parallel. This allows a plurality of loads 12A, 12B, 12C, 12D, 12E to be easily served by the switching system 10. The several electrical connections of the output terminal 20C may be in the form of standard outlets for accepting standard plugs.

The coupling terminal 20D may also consist of several electrical connections in parallel. These electrical connections may also be in the form of standard outlets for accepting standard plugs. These standard outlets may be used to provide simple automatic external maintenance power to the primary power device 14 without requiring an electrician to install another outlet or a circuit breaker. Also, the outlets of the coupling terminal 20D may be used to provide power to a tertiary power device, such as a tertiary UPS (not shown). The tertiary UPS may be used, for example, to provide extended battery backup time to targeted protected loads (not shown).

The automatic switch 11 may also include a number of other enhancements. A first enhancement is an on-off switch (not shown) provided between the relay output terminal 32 and the output terminal 20C to mechanically cut power output to the loads. The on-off switch may also be provided with a circuit breaker. A second enhancement is at least one indicator lights (not shown) to provide a visual indication of which power devices 14, 16 are available and/or in use. A third enhancement is additionally surge or spike suppression devices (not shown) provided with the automatic switch 11. These suppression devices are especially useful when UPSs are not used as the primary and secondary power devices 14, 16.

Obviously, many modifications and variations of the present invention are possible in light of the above teachings. The invention may be practice otherwise than as specifically described within the scope of the appended claims.

What is claimed is:

1. A switching system for maintaining electrical power to a load, said system comprising:
a primary power device;
a secondary power device;
a primary terminal electrically connected to said primary power device;
a secondary terminal electrically connected to said secondary power device;
an output terminal for providing electrical power to the load;
an electromechanical relay for automatically switching between said primary power device and said secondary power device for providing electrical power to the load, said relay comprising:
a first relay input terminal electrically connected to said primary terminal;
a second relay input terminal electrically connected to said secondary terminal;
a relay output terminal electrically connected to said output terminal;
an electromagnet electrically connected to said first relay input terminal;
an electro-magnetically actuated multi-pole activator for electrically connecting said first relay input terminal to said relay output terminal when said electromagnet is energized and for electrically connecting said second relay input terminal to said relay output terminal when said electromagnet is not energized;
a biasing means operatively connected to said multi-pole activator for assisting in the switching of said multi-pole activator when said electromagnet is not energized; and
a coupling terminal electrically interconnecting said secondary terminal and said primary power device for transmitting electrical power from said secondary power device to said primary power device.

2. A switching system as set forth in claim 1 wherein said primary power device is further defined as a primary uninterruptible power supply (UPS) for storing and supplying electrical power.

3. A switching system as set forth in claim 2 wherein said secondary power device is further defined as a secondary UPS for storing and supplying electrical power.

4. A switching system as set forth in claim 3 further comprising an external power source electrically connected to said secondary UPS for providing electrical power to said secondary UPS.

5. A switching system as set forth in claim 2 wherein said secondary power device is further defined as an external power source.

6. A switching system as set forth in claim 1 wherein said biasing means is further defined a spring.

7. A switching system as set forth in claim 1 wherein said electromagnet is an air-core type electromagnet for reducing residual magnetism.
